(19) United States
(12) Patent Application Publication
(10) Pub. No.: US 2016/0142662 A1
(43) Pub. Date: May 19, 2016

(54) DISPLAY APPARATUS AND CONTROL METHOD THEREOF

(71) Applicant: SAMSUNG ELECTRONICS CO., LTD., Suwon-si (KR)

(72) Inventors: Dong-hun LEE, Suwon-si (KR); Sun-young KIM, Suwon-si (KR); Han-soo KIM, Seoul (KR); Woo-seok HWANG, Seoul (KR); Sung-hyuk KWON, Suwon-si (KR); Yong-hwan KWON, Seongnam-si (KR); Jang-won SEO, Seoul (KR); Sang-jin HAN, Gunpo-si (KR)

(73) Assignee: SAMSUNG ELECTRONICS CO., LTD., Suwon-si (KR)

(21) Appl. No.: 14/844,801

(22) Filed: Sep. 3, 2015

(30) Foreign Application Priority Data
Nov. 14, 2014 (KR) 10-2014-0158725

(51) Int. Cl. H04N 5/44; G06F 3/0485; G06F 3/0489; G06F 3/0482

(52) U.S. Cl. CPC H04N 5/4403; G06F 3/0482; G06F 3/0485; G06F 3/04892

(57) ABSTRACT

There is provided a display apparatus which includes a display configured to display a content search user interface (UI) including a scroll element that scrolls contents in a preset direction and a pointer that selects one of the contents according to a scroll command; a user interface configured to receive the scroll command to control a movement of the pointer; and a processor configured to determine a degree of a content search interval between the contents based on a distance between the pointer and the scroll element.

### CROSS-REFERENCE TO RELATED APPLICATION

This application claims priority from Korean Patent Application No. 10-2014-0158725 filed on Nov. 14, 2014 in the Korean Intellectual Property Office, the disclosure of which is incorporated herein by reference in its entirety.

### BACKGROUND

1. Field

Apparatuses and methods consistent with exemplary embodiments relate to a remote controller, a display apparatus, and a method for controlling thereof, and more particularly to, a display apparatus providing a contents search user interface (UI) and a controlling method thereof.

2. Description of the Related Art

With development of electronic technologies, methods for controlling an electronic apparatus using various methods have been developed. In the related art electronic apparatus, an electronic apparatus is controlled by a button provided on an electronic apparatus or by using a remote controller which is separate from the electronic apparatus.

However, in case of the related art electronic apparatus, when controlling an electronic apparatus using a remote controller which is a separate device from an electronic apparatus, a user has to check buttons on a remote controller one by one and perform press manipulation, and thus, a user may feel inconvenience.

For example, in the related art channel conversion method, a desired channel number can be input using number buttons on a remote controller, or channel can be converted by using a channel up/down button, or successive channel conversion method is provided.

However, in case when there are a great number of channels and channel conversion rate is high, it seems inconvenient to convert channels by inputting number buttons by moving fingers, and it is difficult to memorize many channel numbers, it seems difficult to convert change among a diverse range of channels and search for channels by increasing numbers one by one. In addition, when using a channel up/down button, if there are many channels and there are a lot of channel conversion, and more particularly, the channel intervals are large, it may take longer time to convert to a desired channel.

Accordingly, there is necessity of channel conversion method to more conveniently search for and convert channels.

### SUMMARY

One or more exemplary embodiments provide a display apparatus which provides contents searching in a scrolling method and a controlling method thereof.

According to an aspect of an exemplary embodiment, there is provided a display apparatus including: a display configured to display a content search user interface (UI) including a scroll element that scrolls contents in a preset direction and a pointer that selects one of the contents according to a scroll command; a user interface configured to receive the scroll command to control a movement of the pointer; and a processor configured to determine a degree of a content search interval between the contents based on a distance between the pointer and the scroll element.

The processor may be further configured to display an indicator which moves on the scroll element according to the movement of the pointer and display an indicator which indicates a position of a currently searched content among the contents in the preset direction, and finely adjust the content search interval in response to the distance between the pointer and the indicator being greater than a predetermined value.

The contents may be television channels, and the processor may be further configured to enable a fine channel search by reducing a channel mapping amount with respect to a scroll amount which is proportional to a distance between the pointer and the indicator.

The processor may be further configured to provide channel information corresponding to the currently searched channel position on a real time basis.

The user interface may be further configured to receive a pointing interaction from a remote controller. The processor may be further configured to move the pointer placed on the scroll element according to the pointing interaction and search for a channel based on a position of the pointer.

The processor may be further configured to fix the pointer onto the indicator and control the indicator to move on the scroll element in response to the pointer being positioned on the indicator when a user command to move the pointer is received.

The user command may be a touch interaction which is input through a touch pad provided on the remote controller.

The processor may be further configured to search for a channel while the touch interaction is maintained, and in response to the touch interaction being released while a specific channel is searched, perform a channel conversion to the specific channel.

The processor may be further configured to provide visual feedback indicating that fine tuning of channels is available according to the pointer being distant from the indicator by the pointing interaction.

The visual feedback may be an animation effect that the indicator becomes thinner and is connected to a position where the pointer is moved to.

The processor may be further configured to provide visual feedback to the channel search UI when a preferred channel is searched.

The processor may provide a bookmark graphical user interface (GUI) at a position of the scroll element to which a preferred channel is mapped.

According to another aspect of an exemplary embodiment, there is provided a controlling method of a display apparatus including: displaying a content search user interface (UI) including a scroll element that scrolls contents in a preset direction and a pointer that selects one of the contents according to a scroll command; receiving the scroll command to control a movement of the pointer; and determining a degree of a content search interval between the contents based on a distance between the pointer and the scroll element.

The determining the content search interval may include displaying an indicator which indicates a position of a currently searched content among the contents in the preset direction and finely adjusting the content search interval in response to the distance between the pointer and the indicator being greater than a predetermined value.

The contents may be television channels, and the determining the content search interval may include enabling a fine channel search by reducing a channel mapping amount with respect to a scroll amount which is proportional to a distance between the pointer and the indicator.

The method may further include receiving a pointing interaction from a remote controller. The determining the content search interval may include searching for a channel by moving the pointer placed on the scroll element according to the pointing interaction.

The determining the content search interval may include fixing the pointer onto the indicator and controlling the indicator to move on the scroll element in response to the pointer being positioned on the indicator when a user command to move the pointer is received.

The user command is a touch interaction which is input through a touch pad provided on the remote controller.

The determining the content search interval may include providing visual feedback indicating that fine tuning of channels is available according to the pointer being distant from the indicator by the pointing interaction.

The visual feedback may be an animation effect that the indicator becomes thinner and is connected to a position where the pointer is moved to.

According to another aspect of an exemplary embodiment, there is provided a controlling method of a display apparatus including: displaying a scroll element to which a predetermined number of searchable items are assigned, at least one of the searchable items comprising a plurality of sub-items; displaying an indicator at a position in the scroll element to which one of the searchable items is mapped; searching for the searchable items and sub-items according to the position of the indicator; and changing the position of the indicator by a search interval which is set to a coarse interval or a fine interval, the coarse interval corresponding to an interval between two positions of the scroll elements to which adjacent two of the searchable items are assigned, the fine interval corresponding to an interval between two positions of the scroll elements to which adjacent two positions of the sub-items are assigned.

The method may further include displaying a pointer that moves according to a user command, and determining whether the search interval is the coarse interval or the fine interval by comparing a distance between the pointer and the scroll element to a predetermined value.

The scroll element may be a scroll bar displayed in a vertical direction or horizontal direction.

The scroll element may be a circular scroll bar.

The searchable items may be television channels and the sub-items may be sub-channels.

The searchable items may be categories of videos and the sub-items may be videos under each of the categories.

### BRIEF DESCRIPTION OF THE DRAWINGS

The above and/or other aspects will be more apparent by describing certain exemplary embodiments, with reference to the accompanying drawings, in which

FIG. 1 illustrates a configuration of a display system according to an exemplary embodiment.

FIG. 2A is a block diagram illustrating a configuration of a display apparatus according to an exemplary embodiment.

FIG. 2B is a block diagram illustrating a detailed configuration of the display apparatus illustrated in FIG. 2A.

FIG. 3 is a view to describe various software modules stored in a storage.

FIG. 4 is a block diagram illustrating a configuration of a remote control device according to an exemplary embodiment.

FIGS. 5A-5D are views to schematically describe an operation of a display apparatus according to various exemplary embodiments.

FIGS. 6A-6D and FIGS. 7A-7C are views to describe a method for searching a channel according to an exemplary embodiment.

FIGS. 8A and 8B are views to describe a method for providing feedback according to a channel search according to another exemplary embodiment.

FIGS. 9A and 9B are views to describe a method for searching for content according to another exemplary embodiment.

FIGS. 10A and 10B are views to describe a method for searching for content according to still another exemplary embodiment.

FIG. 11 is a flowchart to describe a method for controlling a display apparatus according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments may be practiced without those specifically defined matters. Also, well-known functions or constructions are not described in detail because they would obscure the application with unnecessary detail.

The terms “first”, “second”, and the like may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

A “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor.

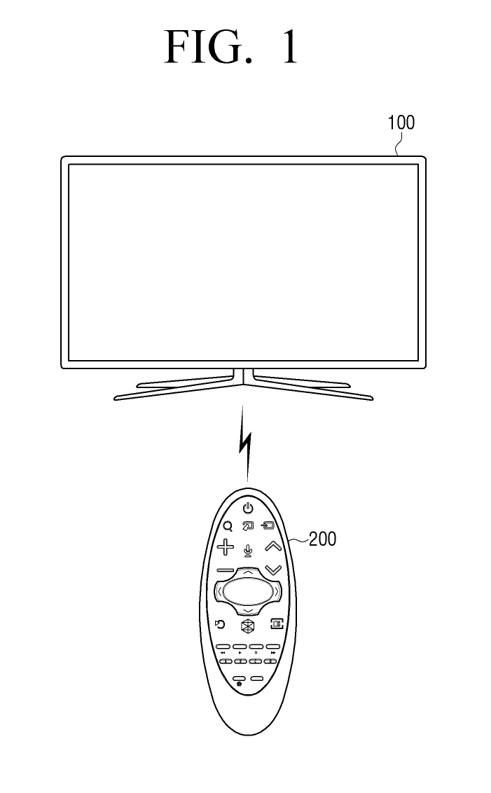

FIG. 1 illustrates a configuration of a display system according to an exemplary embodiment.

As illustrated in FIG. 1, the display system according to an exemplary embodiment includes a display apparatus 100 and a remote controller 200.

The display apparatus 100 is a device controlled by the remote controller 200 and can be embodied as a digital TV, but can be applied to a device which can be remotely controlled such as a personal computer (PC).

The remote controller 200 may remotely control the display apparatus 100, and may receive a user command and transmit a control signal corresponding to the user command to the display apparatus 100.

In particular, the remote controller 200 may detect a movement of the remote controller 200 in XYZ spaces and transmit a signal with respect to the detected three-dimensional signal to the display apparatus 100. Here, the three-dimensional movement may correspond to a command to control the display apparatus 100. That is, a user may deliver a predetermined command to the display apparatus 100 by moving the remote controller 200 on the spaces.

In this case, the remote controller 200 may transmit a signal (hereinafter, a control signal) corresponding to the detected movement information, but may transmit a signal (hereinafter, control information) which is converted to a control command for controlling the signal corresponding to the detected movement information to the display apparatus 100. This can be different depending on whether calculation to calculate control information from the detected movement information is performed in the display apparatus 100 or in the remote controller 200.

In particular, the remote controller 200 may operate with a pointing mode to control a movement state which is displayed in a user interface screen (hereinafter, a UI screen) provided through the display apparatus 100 according to a movement of the remote controller 200. In this case, the remote controller 200 may provide a pointing mode based on an absolute coordinate method to calculate an absolutely moved location with respect to preset criteria of the remote controller 200 or a relative coordinate method to calculate a relatively moved location with respect to a present location of the remote controller 200.

In addition, the remote controller 200 may have a touch pad or a touch screen that recognizes a user touch interaction from contact between a finger or a pen (e.g., a stylus pen) and the touch pad or the touch screen. The remote controller 200 may include a touch sensor or an optical joystick (OJ) which applies optical technology for receiving various types of a touch interaction. In this case, the remote controller 200 may generate a signal corresponding to a touch interaction by detecting a touch interaction on a touch pad, and control the display apparatus 100 according to a corresponding signal.

Meanwhile, according to an exemplary embodiment, the display apparatus 100 may provide a channel search mode based on a pointing interaction of the remote controller 200, which will be further described with reference to drawings.

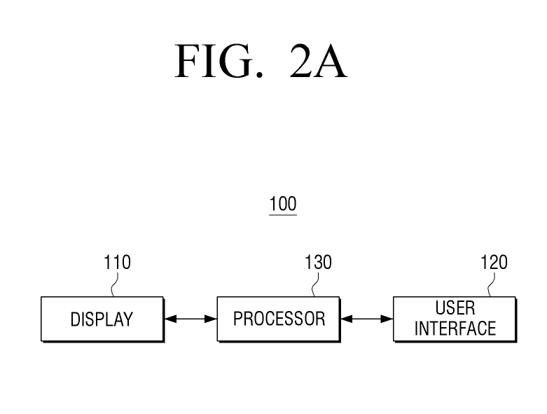

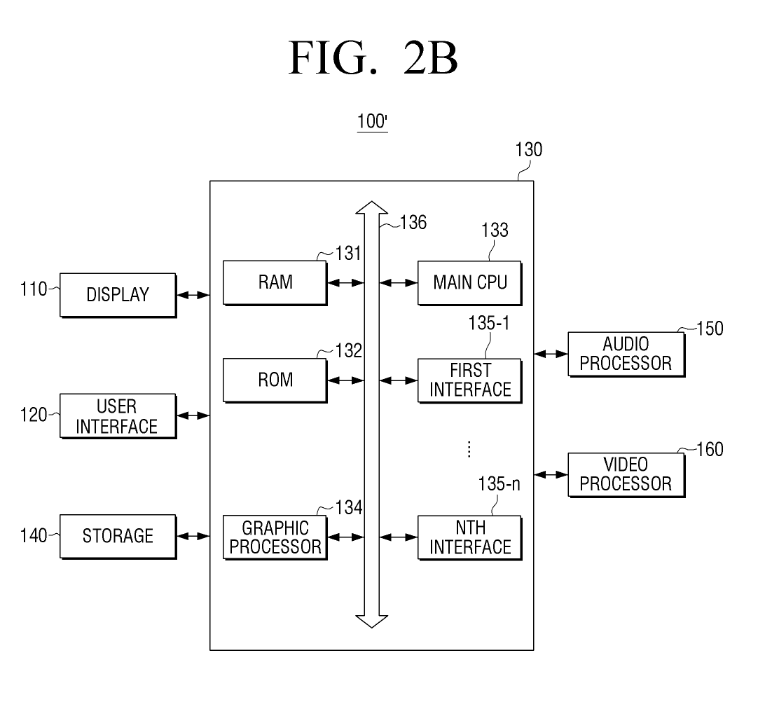

FIG. 2A is a block diagram illustrating the configuration of a display apparatus according to an exemplary embodiment.

According to FIG. 2A, the display apparatus 100 includes the display 110, the user interface 120, and a processor 130.

The display apparatus 100 can be embodied as a digital TV but is not limited thereto, and can be applied to devices capable of providing a TV or communication channel such as a PC, a notebook, a smartphone, and a tablet. Hereinafter, a case where the display apparatus is embodied as a digital TV will be described for easier explanation.

The display 110 may provide a user with various UI screens.

In particular, the display 110 may display a content search UI which allows a user to scroll up and down on the display 110 to input a scroll command by using a pointer so that the display 110 may perform a contents search. Here, the contents search UI can be provided with a scroll bar or a sidebar and a number of contents may be mapped to the contents search UI. In addition, on the channel search UI, an indicator (e.g., a thumb) may move up and down along the and indicate a current scroll position is displayed. In addition, the pointer may be visually indicated as a cursor and a mouse cursor, which may move according to a pointing signal received from the remote controller 200. Meanwhile, when the display apparatus 100 is embodied as a touch-based user terminal such as a smartphone, the pointer 10 may move according to a user touch interaction.

Meanwhile, the display 110 may be embodied as various types of displays such as a liquid crystal display, an organic light-emitting diode, a flexible display, a three-dimensional (3D) display or the like.

The user interface 120 receives various user interactions.

In particular, when the display apparatus 100 is controlled by the remote controller 200, the user interface 120 may be embodied as the remote controller 200 and a communication module which performs communication. To be specific, a communication module can be embodied to support at least one of the various communication methods such as Bluetooth (BT), wireless fidelity (WI-FI), infrared (IR), serial interface, and universal serial bus (USB), or the like.

To be specific, the user interface 120 may receive a user interaction for controlling a movement state of the pointer on a screen.

In particular, the user interface 120 may receive user interactions such as appointing interaction according to a movement on a space on the remote controller 200, an interaction where a preset button (for example, UP/DOWN button) provided on the remote controller 200 is pressed, and a touch interaction which is input through a touch panel provided on the remote controller 200.

The processor 130 performs a function to control overall operations of the display apparatus 100.

In particular, the processor 130 may perform a contents search function on the contents search UI according to a user interaction received through the user interface 120. Here, contents which are mapped to the contents search UI may include various types of contents such as a broadcast channel, video-on-demand (VOD) contents, music contents, photo contents, application, a specific service, a category, and a genre, and a type of a category capable of sorting and filtering. In this case, according to the number of the entire contents which are mapped to the channel search UI, a size of an area where each contents is mapped may be different. For example, a contents mapping interval on the contents search UI may vary based on the number of contents or information (e.g., 1000 channel information, 100 VOD contents, etc.) to be displayed through the contents search UI. Meanwhile, hereinafter, performing a channel search function will be described for easily description.

In this case, the processor 130 may perform a channel search by moving the pointer on the channel search UI according to a user interaction. Here, user interaction may be a pointing interaction according to a movement of the remote controller 200 itself or a touch input made on the remote controller 200, and the processor 130 may move the pointer on the channel search UI according to the received pointing interaction and perform a channel search. However, the embodiments are not limited thereto, and the pointer may move according to various user interactions having directions such as up and down directions and/or left and right directions, which are recognized via a button press or a touch input.

While the pointer is positioned on the indicator, the processor 130 may control a movement state of the indicator through control of the pointer by fixing the pointer on the indicator, according to a user command. Meanwhile, in some cases, the indicator, regardless of the pointer, may be scrolled according to various user interactions having directions such as up and down/left and right buttons and a touch direction having directions. Meanwhile, the indicator may be implemented as a bar-shaped graphical element which may move up and down, for example, on the channel search UI, but the shape of the indicator is not limited thereto, and may be embodied in various shapes. In addition, the processor 130 may change and provide channel information searched by the indicator according to a scroll command by the pointer on a real time basis.

To be specific, the processor 130 may control to, while a touch interaction input through a touch pad provided on the remote controller 200 is received, fix the pointer on the indicator, and move the indicator on the channel search UI according to a movement of the pointer fixed on the indicator. The channel number to be searched may increase or decrease in accordance with the degree to which the indicator moves between one end of the sidebar of the channel search UI and the other end of the sidebar. Meanwhile, a user interaction to fix the pointer on the indicator is not limited to a touch interaction, and may be embodied as various interactions that fix the pointer on the indicator intuitively recognized by a user. For example, an interaction to press a preset button provided on the remote controller 200 may be included.

For example, when the pointer is scrolled up and down according to a pointing interaction while the pointer is fixed on the indicator, a ratio of pointer movement of the to channel conversion may be set to one to one, and a displayed channel number may increase or decrease according to the ratio. For example, if 1000 channels from channel 0001 to channel 1000 are mapped on the channel search UI and the indicator is positioned at about the bottom 20% of the sidebar or scroll bar of the channel search UI, the channel number becomes 200. When the indicator is positioned at the center of the sidebar or scroll bar of the channel search UI, the channel number becomes 500.

The position of the indicator may be represented as an integer, which is within the minimum value and maximum values of the sidebar of the channel search UI. For example, if the sidebar has a range of 0 through 100, position 50 is in the middle and the remaining positions is distributed equally along the sidebar. The range of the sidebar may be set by default or changed by a user command. In this case, channel 0, channel 50, and channel 100 may be assigned to position 0, position 50, and position 100, respectively. When the pointer moves by one position, for example, from position 10 to position 11, the channel number may be converted from channel 10 to channel 11 according to the ratio of pointer movement to channel conversion which is set to 1 to 1.

In addition, the processor 130, when the pointer is distant from the channel search UI, the pointer may adjust channel search intervals based on a degree of distance from the channel search UI.

To be specific, the channel search UI can be displayed in a specific direction, for example, up and down directions, and in this case, the processor 130, when the pointer moves in a horizontal direction which is vertical to up and down direction from the channel search UI, may finely adjust channel search intervals based on a degree of distance of the pointer from the channel search UI.

In this case, the processor 130, in proportion to a degree of distance of the pointer from the indicator, may reduce channel mapping amount regarding the same scroll amount to enable fine channel search.

The number of channels assigned to the channel search UI may be set by default or customized by a user input. For example, a user may set the minimum channel value to “0001” and the maximum channel value to “1000” through the remote controller 200. Also, the amount that the channel value increase or decreases may be determined through user interactions. For example, the user may set a coarse interval (e.g., an interval “1” between Channel 0005 and Channel 0006) and a fine interval (e.g., an interval “0.1” between Channel 0005-1 and Channel 0005-2) between two adjacent channels to be searched. Depending on a distance between the pointer and the sidebar, either the coarse interval or the fine interval may be used to select a channel to be searched and tuned.

For example, on the channel search UI which is provided vertically on a right edge of a screen, when the pointer becomes distant from the indicating after the pointer moves up and down according to the GUI pointing interaction and then the pointer naturally moves to a left side, channel conversion degree changes not sensitively in proportion to a degree of distance. That is, according to a distance between the pointer and the indicator, a ratio of pointer movement to channel conversion may be set to N to 1, wherein N is greater than 1. Specifically, while the pointer is moved to a left side and then moves up and down by one position, the indicator can move slightly less than one position, thus enabling a fine channel adjustment.

Alternatively, the processor 130 may adjust channel search intervals based on a determination of whether the pointer is within a preset threshold distance from the indicator or not. For example, the processor 130, when the pointer is within a preset threshold distance from the indicator, may set the ratio of the pointer movement to channel conversion to one to one, and when the pointer is not within a preset threshold distance from the indicator, may set the ratio of the pointer movement to channel conversion to N to 1, wherein N is greater than 1.

In addition, the processor 130 may provide visual feedback indicating that a fine channel adjustment is available according that the pointer becomes distant from the indicator according to the pointing interaction. Herein, the visual feedback may be an animation effect where the indicator gets thinner and is connected to a position where the pointer moves to.

In addition, the processor 130, when the pointer which is distant from the indicator becomes closer to the indicator again, movement of the indicator becomes greater again, and when the pointer approaches with less than a preset distance to the indicator, the pointer may be automatically positioned on the indicator, and 1:1 channel search can be performed.

In addition, the processor 130 may perform channel conversion to a corresponding channel when the display apparatus 100 is tuned to a certain channel and a touch input is not received for a predetermined time period. Or, the processor 130, during when channel search is performed while the press operation of the preset button is maintained, if press operation of the preset button is released, channel conversion to the corresponding channel may be performed.

Meanwhile, the processor 130, when a channel preferred by a user is searched on the channel search UI, may provide with the channel search UI visual feedback. For example, during scrolling the channel search UI, at the time when a channel preferred by a user is searched, the feedback that entire channel search UI sparkles can be provided. But, the embodiment is not limited thereto, and visual feedbacks to change shadow, color, and size, and so on of the channel search UI can be provided, and in some cases, it is possible to provide visual feedback which is separate from the channel search UI or audio feedback. Meanwhile, a channel preferred by a user may include various types of channels to which user preference can be reflected such as a favorite channel, former channel watched, and so on.

In addition, the processor 130 may provide a bookmark GUI at a position where a channel preferred by a user is mapped on the channel search UI. For example, the processor 130, when 1000 channels from channel number 0001 to channel number 1000 are mapped to the channel search UI, and channel number 200 is a preferred channel, may display the bookmark GUI at a point which is 20% of a lower end of the channel search UI.

FIG. 2B is a block diagram illustrating a detailed configuration of a display apparatus in FIG. 2A.

As illustrated in FIG. 2B, a display apparatus 100′ includes the display 110, the user interface 120, the processor 130, the storage 140, a feedback provider 150, an audio processor 160, and a video processor 170. From among the features illustrated in FIG. 2B, the parts overlapped with those of FIG. 2A will not be further described.

The processor 130 controls overall operations of the display apparatus 100′.

To be specific, the processor 130 includes a random-access memory (RAM) 131, a read-only memory (ROM) 132, a main central processing unit (CPU) 133, a graphic processor 134, the first to n^{th} interface 135-1˜135-n, and a bus 136.

The RAM 131, ROM 132, main CPU 133, graphic processor 134, first to n^{th} interface 135-1˜135-n may be interconnected through the bus 136.

The first to n^{th} interface 135-1 to 135-n are connected with the above-described elements. One of the interfaces can be a network interface connected with an external device through network.

The main CPU 133 performs booting using operating system (O/S) stored in the storage 140, by accessing the storage 140. In addition, various operations can be performed using various programs, contents, data stored in the storage 140.

In the ROM 132, a command set is stored for system booting. When a turn-on command is input and power is supplied, the main CPU 133 copies, to the RAM 131, the O/S stored in the storage 140 according to a command stored in the ROM 132, operates O/S, and boots the system. When booting is completed, the main CPU 133 performs various operations by copying various application programs stored in the storage 140 to the RAM 131 and running an application program copied to the RAM 131.

The graphic processor 134 generates a screen including various objects such as an icon, an image, and a text using a calculating unit and a rendering unit. The calculating unit calculates attribute values such as a coordinate value where ach object is to be displayed according to a layout of a screen based on a received control command, shape, size, color, or the like. The rendering unit generates a screen of various layouts including an object based on an attribute value calculated by the calculating unit. A screen generated in the rendering unit is displayed within a display area of the display 110.

Meanwhile, the operations of the processor 130 can be performed by a program stored in the storage 140.

The storage 140 stores various data such as an O/S module, O/S software module to run the display apparatus 100′ and various multimedia contents.

In particular, the storage 140 may store data for configuring various UI screens provided by the display 110 according to an exemplary embodiment. In addition, the storage 140 may store data for generating a control signal corresponding to various user interactions.

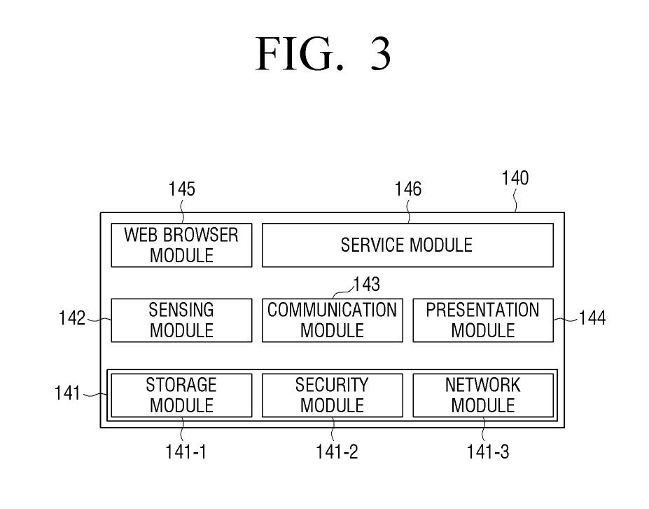

In addition, various software modules stored in the storage 140 will be described with reference to FIG. 3.

According to FIG. 3, the storage 140 may store software including a base module 141, a sensing module 142, a communication module 143, a presentation module 144, a web browser module 145, and a service module 146.

The base module 141 indicates a basic module which processes a signal delivered from each hardware included in the display apparatus 100′ and delivers to an upper layer module. The base module 141 includes a storage module 141-1, a security module 141-2, and a network module 141-3, etc. The storage module 141-1 is a program module which manages database (DB) or registry. The main CPU 143 can read various data by accessing database within the storage 150, by using the storage module 141-1. The security module 151-2 is a program module which supports certification, request permission, security storage regarding hardware, and the network module 141-3 is a module for supporting network connection, which includes DNET module, Universal Plug and Play (UPnP) module, and so on.

The sensing module 142 is a module which collects information from various sensors, and analyzes and manages collected information. The sensing module 142 may include a touch recognition module, a head direction recognition module, a face recognition module, a voice recognition module, a motion recognition module, and a near field communication (NFC) recognition module.

The communication module 143 is a module for performing communication with outside. The communication module 143 may include a device module used for communication with an external device, a messenger program, a short message service (SMS) and multimedia message service (MMS) program, e-mail program, a call info aggregator program module, and a VoIP module.

The presentation module 144 is a module for configuring a display screen. The presentation module 144 may include a multimedia module for replaying and outputting multimedia contents and an UI rendering module for performing UI and graphic processing.

The web browser module 145 indicates a module which performs web browsing and accesses a web server. The web browser module 145 may include various modules such as a web view mode configuring a web page, a download agent module performing download, a bookmark module, and a webkit module.

The service module 146 is a module including various applications for providing various services. To be specific, the service module 146 may include various program modules such as an SNS program, a contents replay program, a game program, an e-book program, a calendar program, an alarm management program, and other widget.

FIG. 3 illustrates various program modules, but may be changed or added partly, according to types and characteristics of the display apparatus 100′. For example, when the display apparatus 100′ is realized as a smartphone, it may be embodied as a type which further includes a location-based module supporting a location-based service in linkage with hardware such as a global positioning system (GPS) chip.

In addition, the display apparatus 100′ may further include an audio processor 150 which performs processing of audio data, a video processor 160 which performs processing of video data, a speaker which outputs audio data processed by the audio processor 150 and alarm sounds, a voice message, or the like, and a microphone for receiving a user voice and other sound to audio data, or the like.

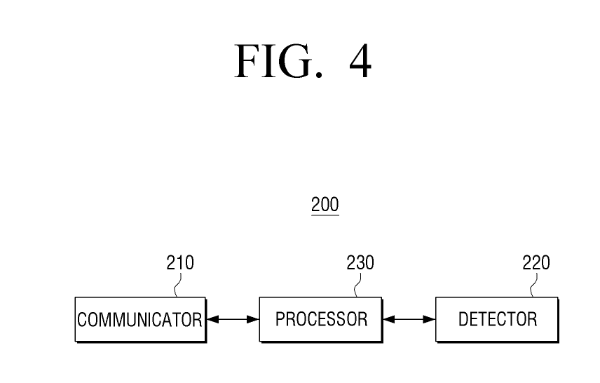

FIG. 4 is a block diagram illustrating a configuration of a remote control device according to an exemplary embodiment.

According to FIG. 4, the remote controller 200 includes a communicator 210, a detector 220, and a processor 230.

The detector 210 detects a three-dimensional movement of the remote controller 200. To be specific, the detector 210 may include at least one of an acceleration sensor, a gyro sensor, and a terrestrial magnetism sensor. The various sensors included in the detector 210 may detect a spatial movement of the remote controller 200 through one or more combination thereof.

For example, the acceleration sensor may detect at least one of changes in acceleration (e.g., angular acceleration) which occurs when the remote controller 200 moves, the gyro sensor may detect a rotation angular acceleration of the remote controller 200, and the terrestrial sensor may measure azimuth by detecting magnetic field formed in south and north directions of a sphere.

In addition, when a touch pad is provided on the remote controller 200, the detector 210 may detect a touch interaction by fingers or pen (for example, stylus pen) through a touch sensor.

The communicator 220 performs communication with the display 100 and transmits a signal generated by the remote controller 200.

In particular, the communicator 220 may transmit a movement signal, a touch signal, and a button signal detected in the detector 210 to the display apparatus 100.

In this case, the communicator 220 may transmit, to the display apparatus 100, information related to the remote controller such as Bluetooth (BT), Z WiFi (Wireless Fidelity), IR (Infrared), Serial Interface, universal serial bus (USB) and so on.

The processor 230 controls the overall operation of the remote controller 200. For example, the processor 230 may be embodied as a central processing unit (CPU) or a microcontroller unit (MCU), or the like. To be specific, the processor 230 may control the operation of the detector 210 and the communicator 220.

In particular, the processor 230, when spatial movement of the remote controller 200 is detected, may generate a control signal corresponding to the spatial movement or control information and transmit to the display apparatus 100.

In addition, the processor 230, when a touch interaction to touch a touch panel provided on the remote controller 200 or an interaction to press a preset button on the remote controller 200 is detected, may control to generate a signal corresponding to the detected interaction and transmit the signal to the display apparatus 100. For example, the processor 230, while a touch interaction is maintained, may successively transmit a corresponding signal so that the pointer is fixed to the indicator on the channel search UI in the display apparatus 200.

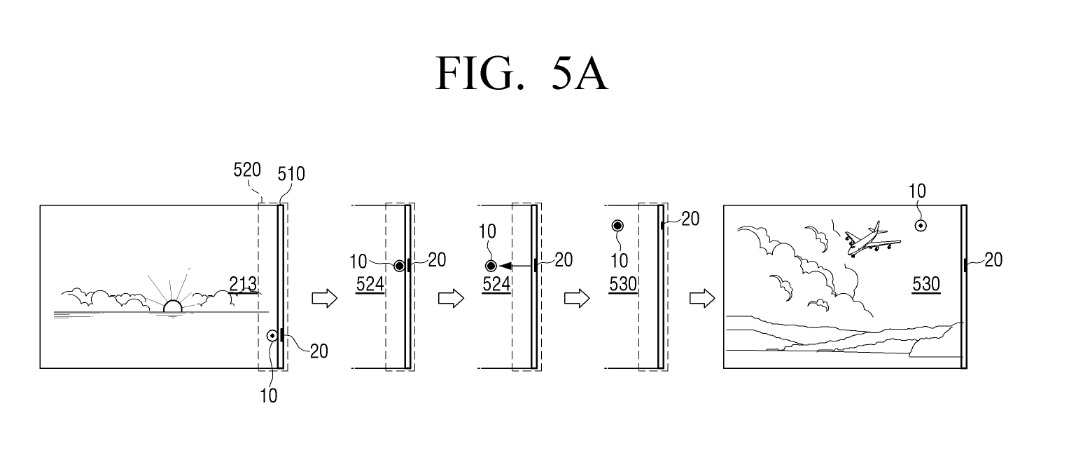

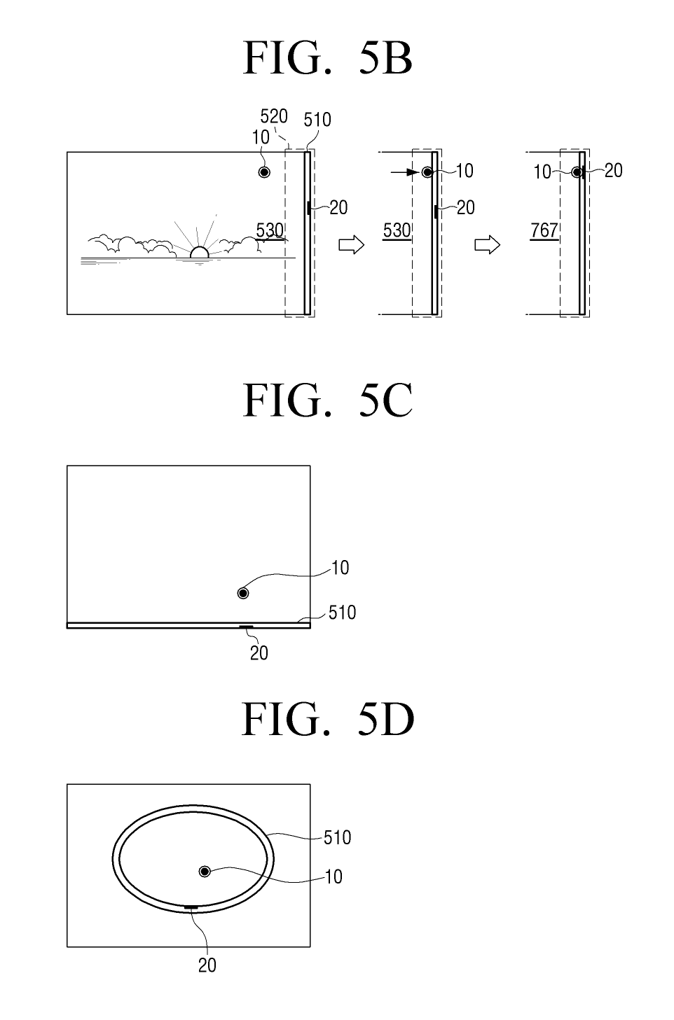

FIGS. 5A and 5B are views to schematically describe an operation of a display apparatus according to various exemplary embodiments.

FIG. 5A shows that the pointer 10 scrolls the indicator 20 on the sidebar 510 of the channel search UI on a preset event and searches for a channel. In this case, within the preset threshold area 520, the ratio of pointer movement to channel conversion may be set to one to one. Here, the preset event may be a touch interaction, and visual feedback may be provided through the pointer 10 according to a touch interaction. For example, as illustrated above, the size of the inner circle of the pointer may be enlarged.

Then, when the pointer 10 is moved to outside of the preset threshold area 520, the ratio of pointer movement to channel conversion may change to N:1 (N>1). That is, fine channel adjustment is available. In this case, when the length of the bar-shaped indicator 20 may be reduced, and a smaller graphical element may be displayed.

Then, if a touch interaction is released, channel conversion to a searched channel may be performed. In this case, the size of the inner circle of the pointer 10 may be reduced again.

According to FIG. 5B, when the pointer 10 moves close to the sidebar 510 of the channel search UI according to a user interaction, the indicator 20 may move to a position corresponding to a position of the moved pointer 10, and a channel corresponding to a position of the pointer 10 may be searched. For example, if the indicator 20 moves to a new position where the pointer 10 is currently located while a channel number “530” is being searched according to a previous position of the indicator 20, a channel number 767 which corresponds to the new position may be searched.

FIG. 5B illustrates the sidebar 510 in a vertical direction, but the present embodiment is not limited thereto. For example, as shown in FIG. 5C, the sidebar 510 may be placed in a horizontal direction. Also, the sidebar 510 may be replaced with a circular scroll bar 510 as shown in FIG. 5D.

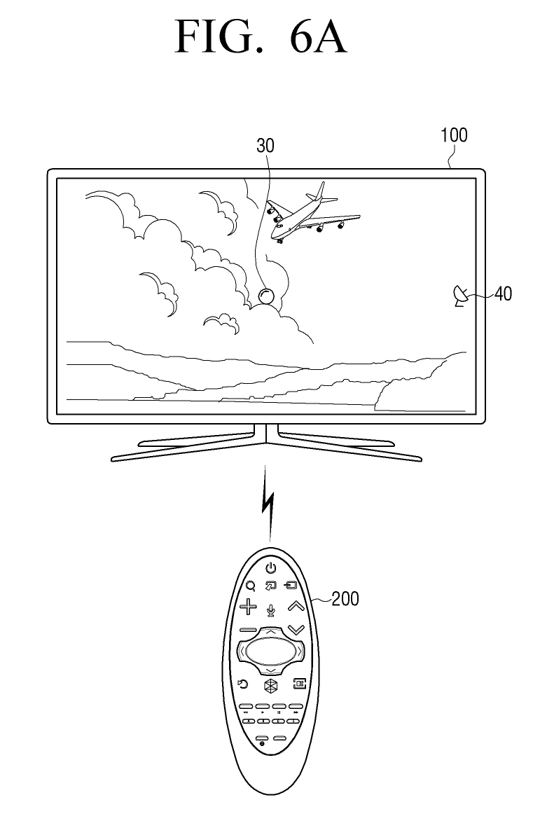

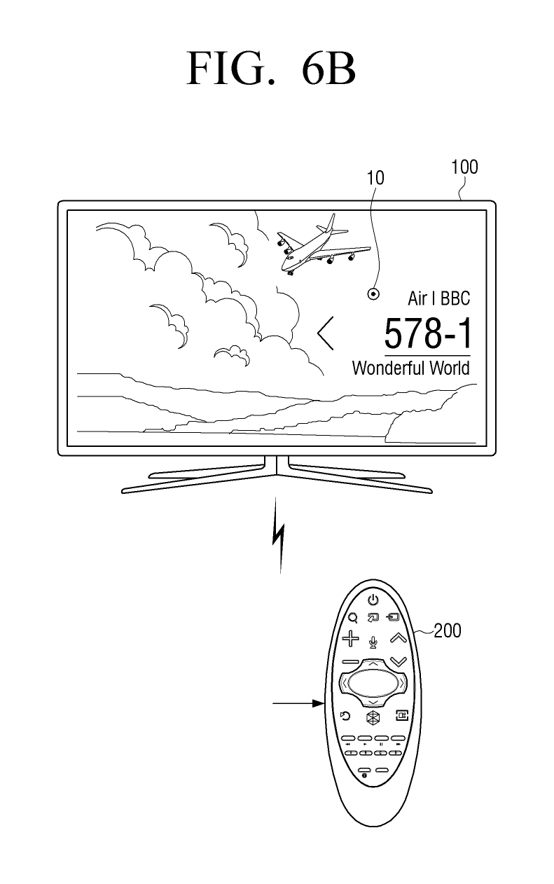

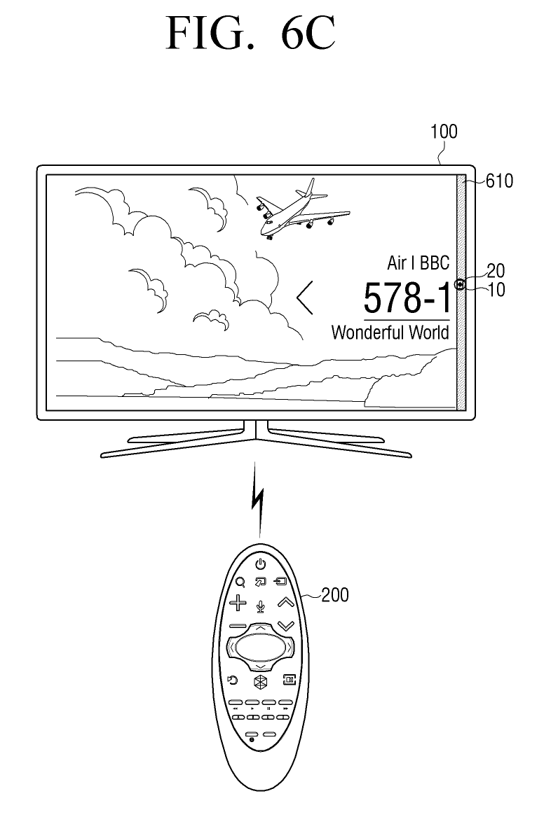

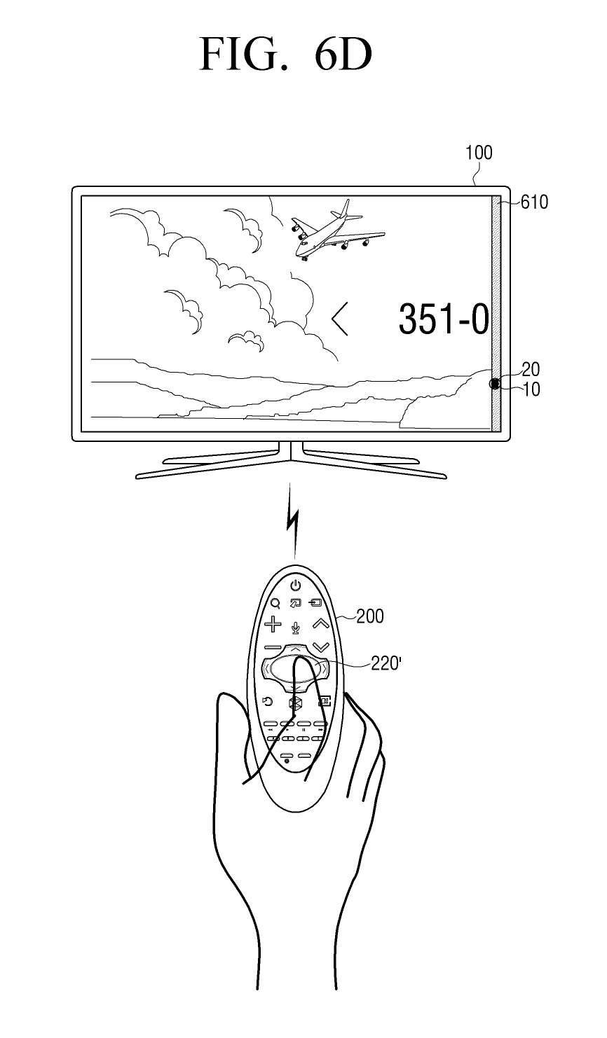

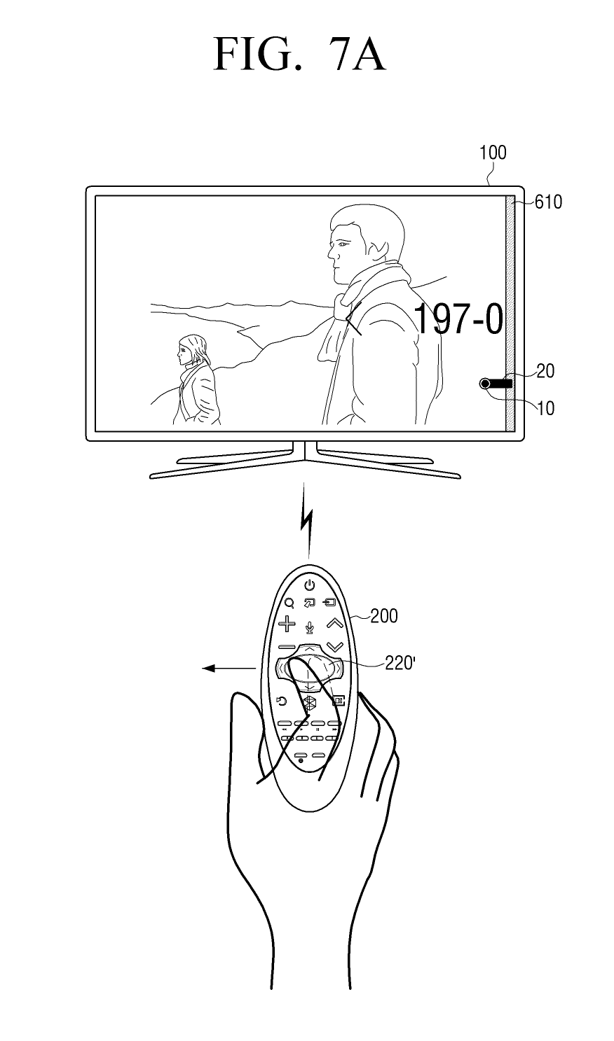

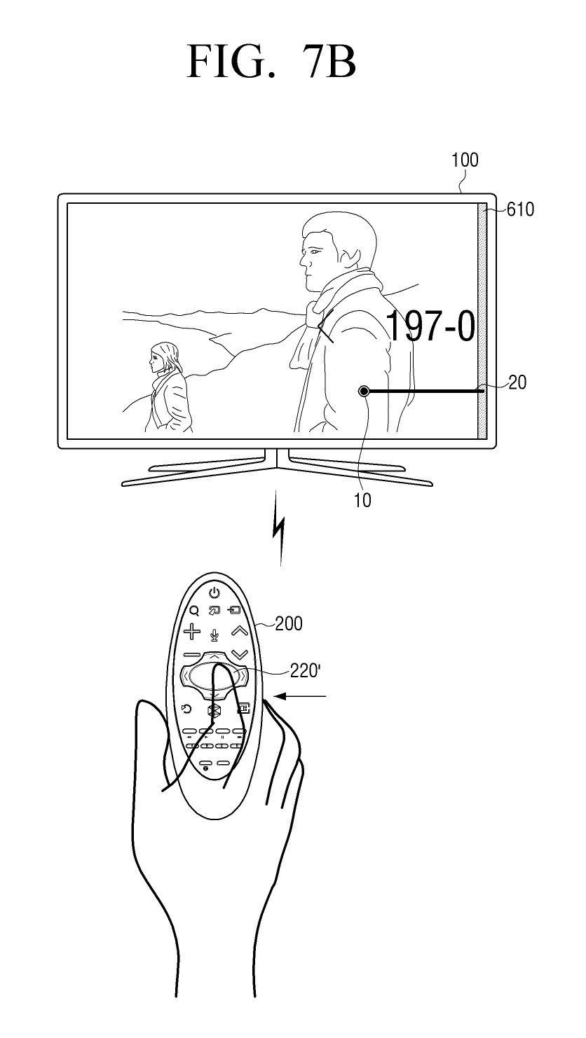

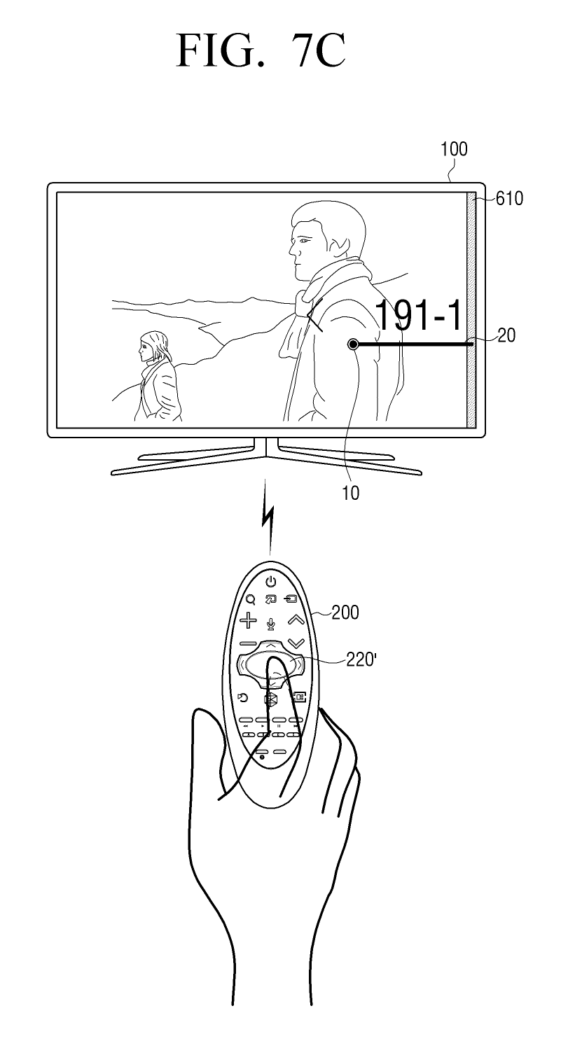

FIGS. 6A-6D and FIGS. 7A-7C are views to describe a method for searching a channel according to an exemplary embodiment.

As illustrated in FIG. 6A, while a preset GUI 30 and a tuner icon 40 are provided on an initial screen of the display apparatus 100, the preset GUI 30 may be changed to the pointer 10 according to a movement of the remote controller 200. When the pointer 10 moves close to the tuner icon 40, information of a tuned channel may be provided at a position where the tuner icon 40 is displayed as illustrated in FIG. 6B. Herein, though not illustrated in an initial screen, various menus (for example, a home menu, sound adjustment menu, etc.) other than the tuner icon 40 may be provided.

Then, as illustrated in FIG. 6C, when the pointer 10 moves to the right end corner of the display apparatus 100, a scrollable channel search UI 610 may be displayed and the indicator 20 may be provided on the sidebar 610 of the channel search UI.

Then, as illustrated in FIG. 6D, when a touch interaction is input to a touch panel 220′ provided on the remote controller 200, the pointer 10 may be fixed on the indicator 20 and perform a channel search function. That is, a touch interaction fixes the pointer 10 on the indicator 20, and enables the pointer 10 to scroll the indicator 20 and perform a channel search according to a movement of a remote controller 100 or an input to the remote controller 100. Meanwhile, this fixing function can be embodied through various interactions such as an operation to press a preset button provided on a front surface, a side surface, and a back surface of the remote controller 200. Meanwhile, when a touch interaction is input, visual feedback may be provided to the pointer 10. For example, as illustrated, the size of the inner circle of the pointer 10 may be enlarged.

Meanwhile, as illustrated in FIG. 6C, when the pointer 10 scrolls the indicator 20 on the sidebar 610 of the channel search UI and performs a channel search, the ratio of pointer movement to channel conversion may be set to one to one. If the pointer 10 is distant from the indicator 20, scrolls the indicator 20, and performs a channel search, the ratio of pointer movement to channel conversion may be set to N to 1, wherein N is greater than 1, and fine channel adjustment is available.

As illustrated in FIG. 7A, while a touch interaction is maintained, when the remote controller 200 moves to a right side, the pointer 10 also moves to a right side, away from the channel search UI 610. In this case, visual feedback may be provided when the pointer 10 drags the indicator 20 to a new position on the sidebar 610 of the channel search UI. To be specific, as illustrated in FIG. 7B, as much as the pointer 10 being distant from the channel search UI 610, the indicator 20 gets thinner, and has the effect of giving visual feedback that fine channel adjustment is available.

Then, as illustrated in FIG. 7C, while the pointer 10 is distant from the channel search UI 610, when a movement of the remote controller 200 corresponding to a scroll manipulation is detected, fine channel adjustment becomes available.

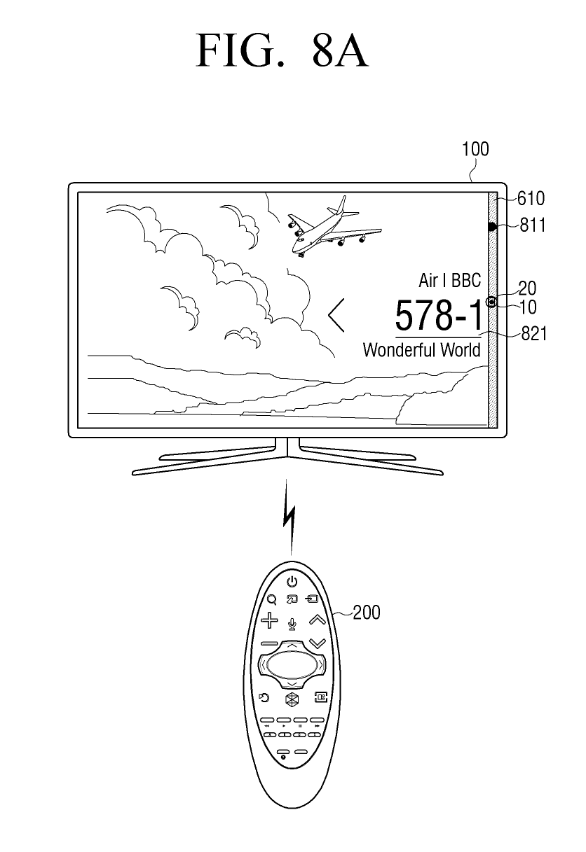

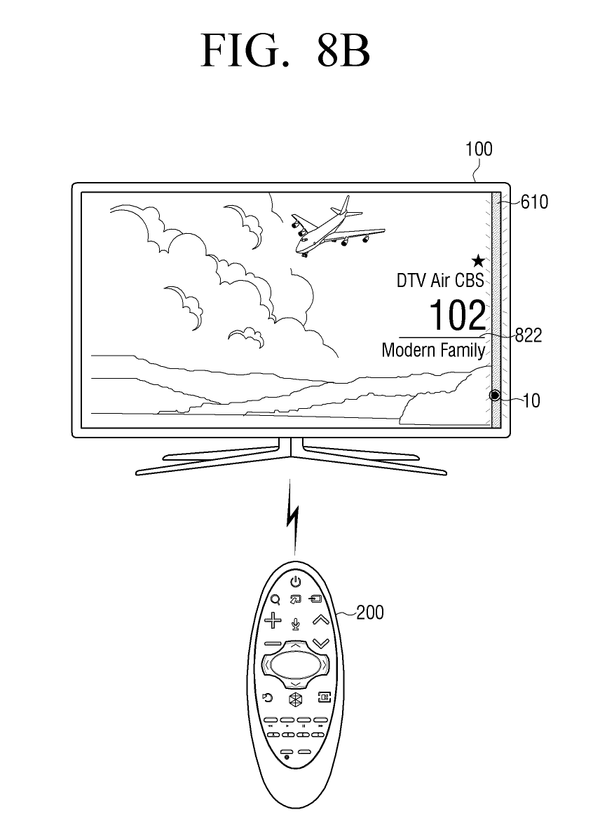

FIGS. 8A and 8B are views to describe a method for providing feedback according to a channel search according to another exemplary embodiment.

As illustrated in FIG. 8A, a bookmark GUI 811 may be provided on a position where a channel preferred by a user is mapped on the channel search UI 610, as illustrated. For example, when 1000 channels from channel 0001 to channel 1000 are mapped on the channel search UI, and channel 102 is saved as a preferred channel or a favorite channel, the bookmark GUI 811 may be displayed at a position of 10% at a lower end of the channel search UI. Here, a channel preferred by a user may include various types of channels such as a favorite channel, a former channel, and so on, to which user preference can be reflected.

Then, if a channel preferred by a user is searched on the channel search UI, visual feedback can be provided on the channel search UI 610 as illustrated in FIG. 8B. For example, while the indicator 10 is scrolled up or down to search for a channel bookmarked by a user as a preferred channel, the sidebar 610 of the channel search UI may flash to provide some feedback. However, the present embodiment is not limited thereto, and visual feedback to change shadow, color, size of the channel search UI may be provided.

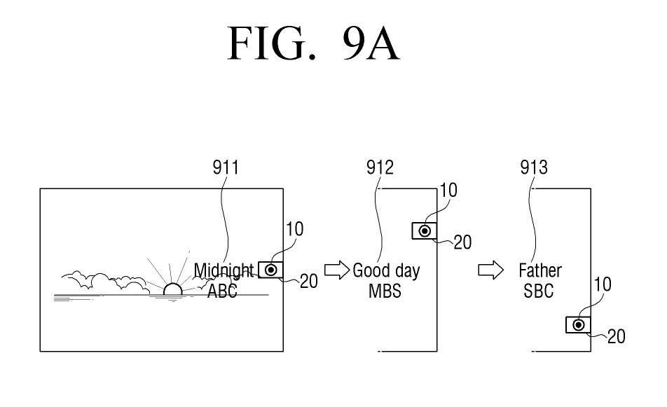

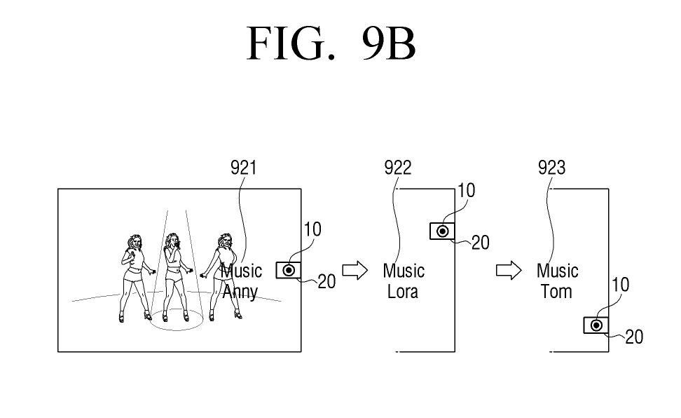

FIGS. 9A and 9B are views to describe a method for searching for contents according to another exemplary embodiment.

As illustrated in FIG. 9A, the pointer 10 scrolls the indicator 20 on the contents search UI according to a preset event, and may perform a search (e.g., 911→912→913) for VOD contents or, as illustrated in FIG. 9B, perform a search (e.g., 921→922→923) for music contents. Here, the indicator 20 may be displayed with various formats. In particular, the indicator 20, while it is in a thin bar as illustrated in FIG. 5A, and is selected by the pointer 10, may be displayed in an area where the pointer 10 is displayed as illustrated in FIG. 9A.

In this case, when the pointer 10 moves to outside of a preset threshold area, that is, more than a preset distance in a left direction, fine adjustment of contents is available.

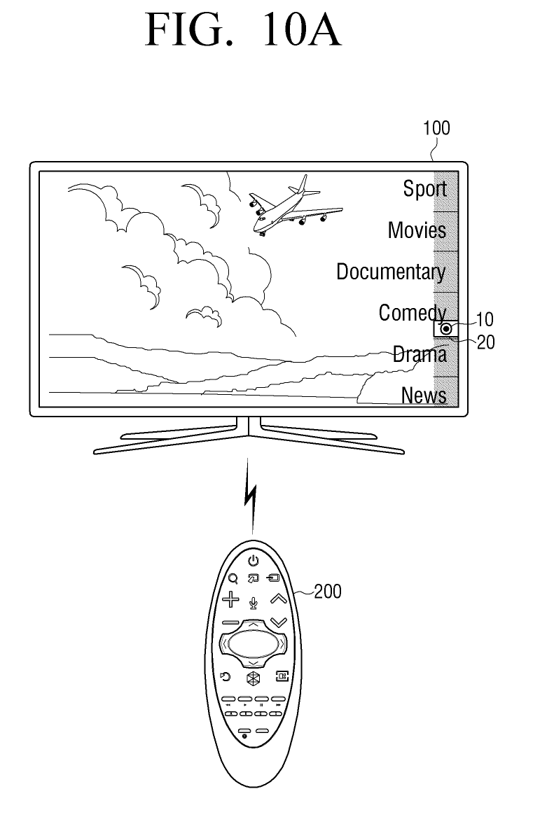

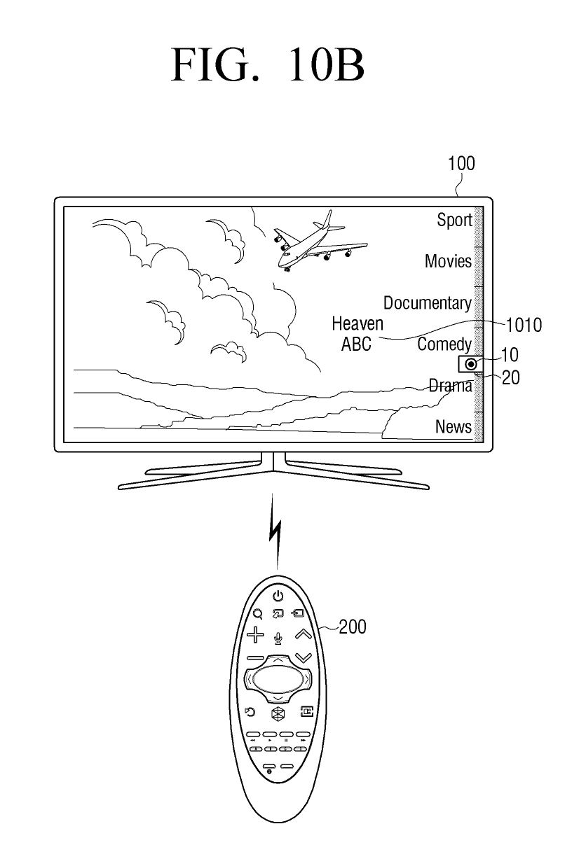

FIGS. 10A and 10B are views to describe a method for searching for content according to still another exemplary embodiment.

As illustrated in FIG. 10A, according to an exemplary embodiment, the contents search UI may be divided into an area corresponding to a category, and may display a specific filtering area. In this case, each content may be mapped to one area on the contents search UI, and a plurality of mapping areas to which contents are mapped can be provided as a specific filtering area corresponding to a category. Accordingly, a user may move the pointer 10 to a desired area, move the GUI to a desired category, and select a desired content.

In addition, according to another exemplary embodiment, an area corresponding to each category on the contents search UI may map to one area. In this case, through a preset button of the remote controller 200, for example, an up/down button, the indicator 20 may move from one area to another to select a desired category among the categories provided by the content search UI. Meanwhile, in a pointing mode, if a signal according to manipulation of up/down button is received, the pointer 10 may be moved by one area on the contents search UI and moved to a desired category.

In addition, when a specific category is selected using an up/down button, the contents belonging to a corresponding category may be remapped on the contents search UI.

As illustrated in FIG. 10B, contents information 1010, which is selected according to a scroll command and a category selection, may be displayed at the same time, and desired contents may be selected easily through scrolling. Alternatively, when a category is selected according to an exemplary embodiment, and the pointer 10 moves to outside of a preset threshold area, a fine adjustment of the contents is available within a corresponding category.

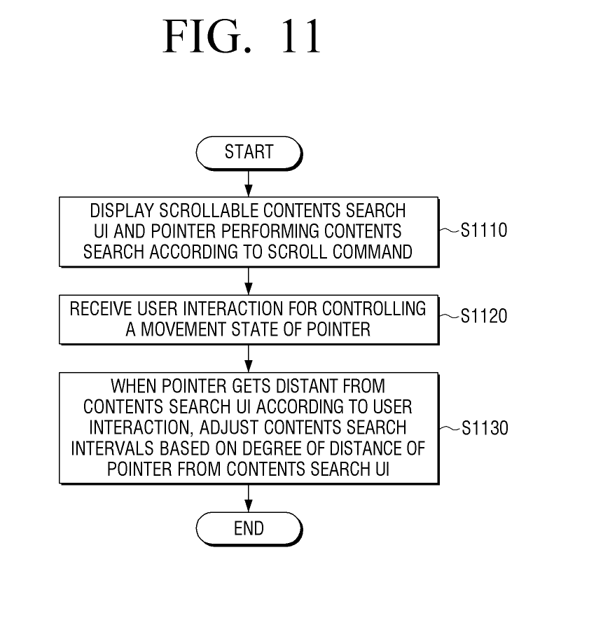

FIG. 11 is a flowchart to describe a method for controlling a display apparatus according to an exemplary embodiment.

According to a method of controlling the display apparatus as illustrated in FIG. 11, first of all, the contents search UI which may be scrolled in a preset direction and the pointer which performs contents search according to a scroll command are displayed (operation S1110).

Then, in order to control a movement state of the pointer, user interaction is received (operation S1120).

Then, when the pointer gets farther from the contents search UI according to a user interaction, channel search intervals are adjusted based on a distance between the pointer and the sidebar of the contents search UI (operation S1130). Here, the contents search UI may be the channel search UI, but is not limited thereto.

In this case, at operation S1130 for adjusting a channel search interval, the indicator indicating the currently searched channel position while moving according to control of the pointer on the channel search UI may be displayed, and when the pointer is distant from the indicator according to a user interaction, channel search intervals can be finely adjusted based on a degree of distance.

In addition, the control method may include, when a preset user interaction is received while the pointer is positioned on the indicator, fixing the pointer on the indicator while a preset user interaction is received, and controlling the indicator to move on the channel search UI according to movement of the pointer fixed on the indicating, and performing a channel search.

In this case, channel information searched by the indicator according to a scroll command may be changed on a real time basis.

Here, a user interaction for moving the pointer is a pointing interaction according to spatial movement of a remote controller, and a user interaction for fixing the pointer on the indicator may be a touch interaction which is input through a touch pad provided on the remote controller.

In addition, the method for controlling may further include performing a channel search while a touch interaction is maintained, and when the touch interaction is released while a specific channel is searched, performing channel conversion to a specific channel may be further included.

In addition, at operation S1130 for adjusting channel search intervals, the pointer may reduce a channel mapping amount regarding the same scroll amount in proportion to the distance from the indicator, and enable a fine channel search.

In addition, at operation S1130 for adjusting a channel search interval, some visual feedback indicating that fine channel adjustment is available according to distance of the pointer from the indicator according to the pointing interaction may be provided. Here, the visual feedback can be an animation effect which connects the pointer where the indicator gets thinner is connected to a position where the pointer is moved to.

In addition, a controlling method may further include, when a channel preferred by a user is searched on the channel search UI, providing visual feedback to the channel search UI.

As described above, according to the various exemplary embodiments, a rapid and intuitive channel search and conversion methods may be provided.

Meanwhile, the methods according to the above-described various exemplary embodiments may be embodied by upgrading software previously installed in a display apparatus or a user terminal device.

The controlling method of the display apparatus according to various exemplary embodiments described above may be implemented in a program so as to be provided to the display apparatus. Particularly, the program including the controlling method of the display apparatus may be stored and provided in a non-transitory computer readable medium.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units of the above-described apparatuses and devices can include circuitry, a processor, a microprocessor, etc., and may execute a computer program stored in a computer-readable medium.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to display a content search user interface (UI) including a scroll element that scrolls contents in a preset direction and a pointer that selects one of the contents according to a scroll command;
a user interface configured to receive the scroll command to control a movement of the pointer; and
a processor configured to determine a degree of a content search interval between the contents based on a distance between the pointer and the scroll element.

2. The display apparatus as claimed in claim 1, wherein the processor is further configured to display an indicator which moves on the scroll element according to the movement of the pointer and display an indicator which indicates a position of a currently searched content among the contents in the preset direction, and finely adjust the content search interval in response to the distance between the pointer and the indicator being greater than a predetermined value.

3. The display apparatus as claimed in claim 2, wherein the contents are television channels, and the processor is further configured to enable a fine channel search by reducing a channel mapping amount with respect to a scroll amount which is proportional to a distance between the pointer and the indicator.

4. The display apparatus as claimed in claim 2, wherein the contents are television channels, and the processor is further configured to provide channel information corresponding to the currently searched channel position on a real time basis.

5. The display apparatus as claimed in claim 2, wherein the user interface is further configured to receive a pointing interaction from a remote controller, and
wherein the processor is further configured to move the pointer placed on the scroll element according to the pointing interaction and search for a channel based on a position of the pointer.

6. The display apparatus as claimed in claim 5, wherein the processor is further configured to fix the pointer onto the indicator and control the indicator to move on the scroll element in response to the pointer being positioned on the indicator when a user command to move the pointer is received.

7. The display apparatus as claimed in claim 6, wherein the user command is a touch interaction which is input through a touch pad provided on the remote controller.

8. The display apparatus as claimed in claim 7, wherein the processor is further configured to search for a channel while the touch interaction is maintained, and in response to the touch interaction being released while a specific channel is searched, perform a channel conversion to the specific channel.

9. The display apparatus as claimed in claim 6, wherein the processor is further configured to provide visual feedback indicating that fine tuning of channels is available according to the pointer being distant from the indicator by the pointing interaction.

10. The display apparatus as claimed in claim 9, wherein the visual feedback is an animation effect that the indicator becomes thinner and is connected to a position where the pointer is moved to.

11. The display apparatus as claimed in claim 1, wherein the processor is further configured to provide visual feedback to the channel search UI when a preferred channel is searched.

12. The display apparatus as claimed in claim 1, wherein the processor provides a bookmark graphical user interface (GUI) at a position of the scroll element to which a preferred channel is mapped.

13. A controlling method of a display apparatus, the method comprising:
displaying a content search user interface (UI) including a scroll element that scrolls contents in a preset direction and a pointer that selects one of the contents according to a scroll command;
receiving the scroll command to control a movement of the pointer; and
determining a degree of a content search interval between the contents based on a distance between the pointer and the scroll element.

14. The method as claimed in claim 13, wherein the determining the content search interval comprises displaying an indicator which indicates a position of a currently searched content among the contents in the preset direction and finely adjusting the content search interval in response to the distance between the pointer and the indicator being greater than a predetermined value.

15. A controlling method of a display apparatus, the method comprising:
displaying a scroll element to which a predetermined number of searchable items are assigned, at least one of the searchable items comprising a plurality of sub-items;
displaying an indicator at a position in the scroll element to which one of the searchable items is mapped;
searching for the searchable items and sub-items according to the position of the indicator; and
changing the position of the indicator by a search interval which is set to a coarse interval or a fine interval, the coarse interval corresponding to an interval between two positions of the scroll elements to which adjacent two of the searchable items are assigned, the fine interval corresponding to an interval between two positions of the scroll elements to which adjacent two positions of the sub-items are assigned.

16. The method as claimed in claim 15, further displaying a pointer that moves according to a user command, and determining whether the search interval is the coarse interval or the fine interval by comparing a distance between the pointer and the scroll element to a predetermined value.

17. The method as claimed in claim 15, wherein the scroll element is a scroll bar displayed in a vertical direction or horizontal direction.

18. The method as claimed in claim 15, wherein the scroll element is a circular scroll bar.

19. The method as claimed in claim 15, wherein the searchable items are television channels and the sub-items are sub-channels.

20. The method as claimed in claim 15, wherein the searchable items are categories of videos and the sub-items are videos under each of the categories.
